(19) United States
(12) Patent Application Publication
(10) Pub. No.: US 2012/0268661 A1
(43) Pub. Date: Oct. 25, 2012

(54) TELEVISION TOGGLER REMOTE CONTROL

(76) Inventors: Fred Hartman, Arroyo Grande, CA (US); Pat Hartman, Arroyo Grande, CA (US)

(21) Appl. No.: 13/092,897

(22) Filed: Apr. 22, 2011

(51) Int. Cl. H04N 5/44

(52) U.S. Cl. 348/734; 348/E05.097

(57) ABSTRACT

A remote control device allows a viewer to toggle between a plurality of preselected programs at will. The remote control device may be simple to program and may include from three to about seven, typically about 5, programmable keys that would change a television program at the touch of a single button. The remote control device may include numerical keys for programming the programmable keys, an enter key and a clear key, also used for programming functions, the programmable keys, a power button, and a back key and a next key to move through the channels programmed in the programmable keys.

### BACKGROUND OF THE INVENTION

The present invention relates to television remote controls and, more particularly, to television remote controls offering the user the ability to toggle between a plurality of preselected programs.

Remote controls have become more and more complex over time, offering the user options to control multiple devices, including televisions, radios, video players/recorders, sound systems and even lighting and window shades. Many times, when a user wants to change a television channel, the user must first push a device button (in this case, TV) and then push the selected numbers corresponding to the desired channel. To change the channel, the user must push the selected numbers corresponding to the new desired channel.

Conventional remotes often allow a user to recall the previous channel selected. However, if the user desires to switch between more than two channels, the user must know the channel numbers for each channel and enter the numbers each time a channel change is desired. While some remotes may allow the programming of favorite channels, these remotes are complex and may be difficult to program, even to the technically savvy user.

Many networks offer high definition options for their channels. Many cable and/or satellite providers offer these channels, usually as a three or four digit channel number. If a user wishes to switch between three, four or more of these channels quickly, the user must know the channel numbers of each channel. The time to switch between channels may be delayed, especially when the channels have four digits to be entered. When a user is switching between sporting events on multiple channels, the extra time needed to enter the channel digits on the remote may be enough time to miss an exciting play.

As can be seen, there is a need for a television remote control that has a simple design that may toggle between a plurality of programs by the push of a single button.

### SUMMARY OF THE INVENTION

In one aspect of the present invention, a remote control device comprises a plurality of program buttons, each of the program buttons being programmable to transmit a signal to change a device to a particular television channel; a next button to toggle forward through the plurality of program buttons; and a back button to toggle backwards through the plurality of program buttons.

In another aspect of the present invention, a remote control device consists essentially of a plurality of program buttons, each of the program buttons being programmable to transmit a signal to change a device to a particular television channel; a next button to toggle forward through the plurality of program buttons; a back button to toggle backwards through the plurality of program buttons; a power button for turning the device on and off; and programming buttons adapted to provide a user a means for programming the plurality of program buttons.

In a further aspect of the present invention, a method for toggling between channels of television programming comprises programming a plurality of program buttons of a remote control device, each of the program buttons being programmable to transmit a signal to change a device to a particular television channel; pressing a next button to toggle forward through the plurality of program buttons; and pressing a back button to toggle backwards through the plurality of program buttons.

These and other features, aspects and advantages of the present invention will become better understood with reference to the following drawings, description and claims.

### BRIEF DESCRIPTION OF THE DRAWINGS

FIG. 1 is a top view of a remote control device according to an exemplary embodiment of the present invention;

FIG. 2 is a front perspective view of the remote control device of FIG. 1;

FIG. 3 is a side perspective view of the remote control device of FIG. 1; and

FIG. 4 is a perspective view of the remote control device of FIG. 1 positioned on a table top.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a remote control device that allows a viewer to toggle between a plurality of preselected programs at will. The remote control device may be simple to program and may include from three to about seven, typically about 5, programmable keys that would change a television program at the touch of a single button. The remote control device may include numerical keys for programming the programmable keys, an enter key and a clear key, also used for programming functions, the programmable keys, a power button, and a back key and a next key to move through the channels programmed in the programmable keys.

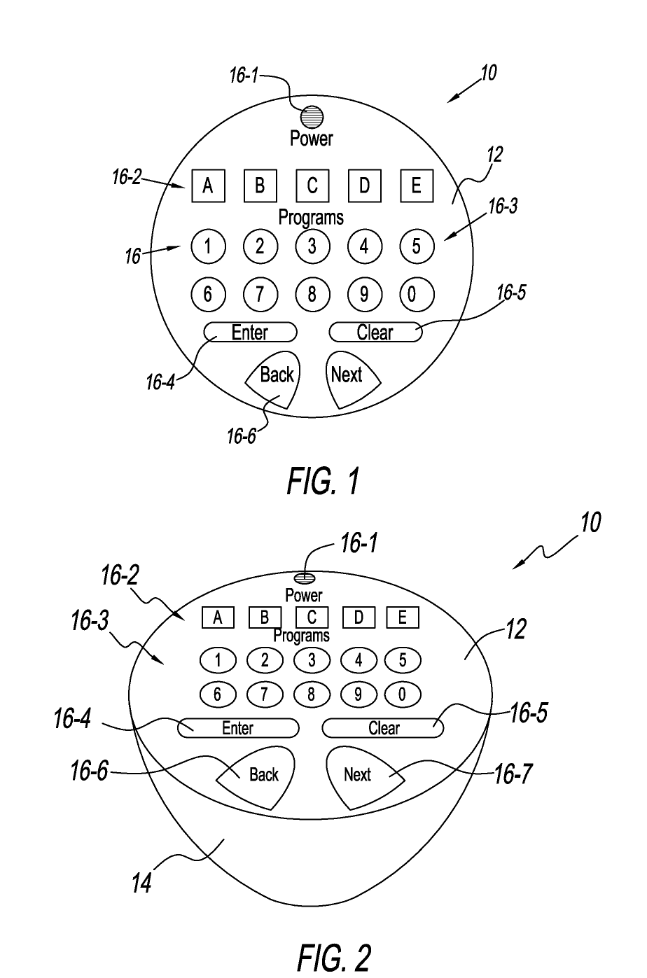

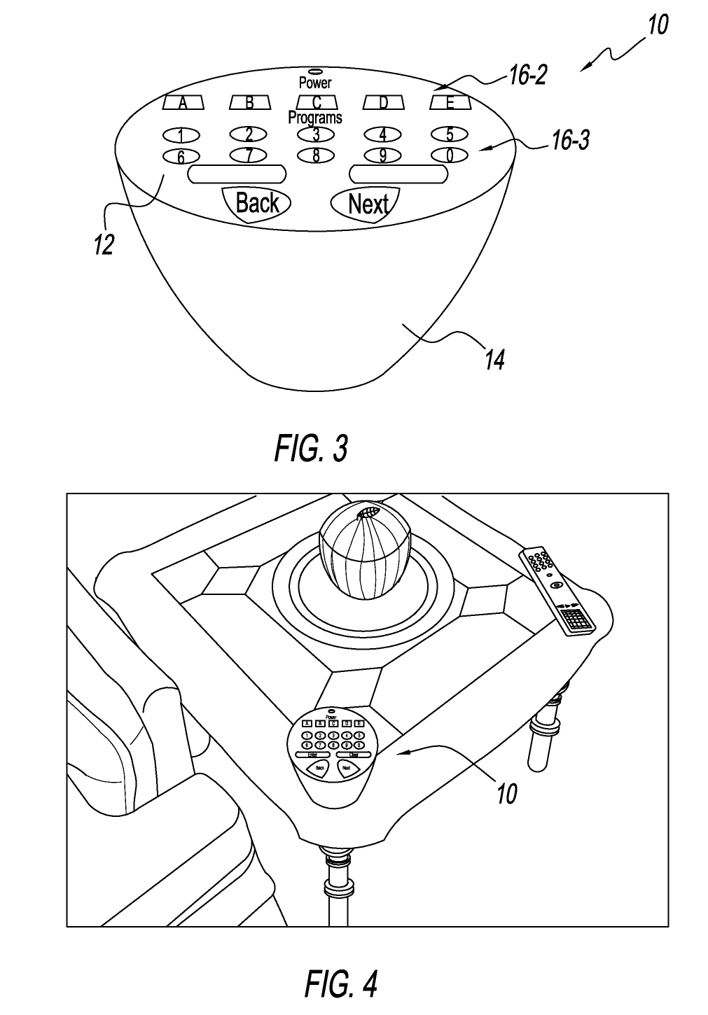

Referring to FIGS. 1 through 4, a remote control device 10 includes a touch sensitive top surface 12 and a housing 14. The top surface 12 may include a plurality of buttons 16 that, when depressed by a user, transmit a signal to electronics (not shown) inside the housing 14. These electronics may be typical remote control electronics and may include a processor for receiving signals from the buttons 16, a transmitter for sending a signal to a television, cable box, satellite box, or the like, and logic for configuring the remote to be compatible with various brands of televisions, cable boxes, satellite boxes, and the like.

The housing 14 may have a bowl shape, typically a rice bowl shape. Such a shape may help prevent loss of the device 10 (for example, between cushions of furniture), may provide a remote that matches home decor, as shown in FIG. 4, better than conventional remotes, and may fit, for example, comfortably between a seated user's legs. This design may be helpful for persons with disabilities, for example, where the remote may be readily accessed when disposed between a seated user's legs. Moreover, a user may be free to use his or her thumbs for toggling the next and back buttons of the remote, as described below. The housing 14 may be provided in various colors and may be designed with team colors or logos, according to the user's preferences.

The buttons 16 may include a power button 16-1, a plurality of program buttons 16-2 (labeled A through E in the figures), a numeric keypad 16-3, an enter button 16-4, a clear button 16-5, a back button 16-6 and a next button 16-7. The buttons 16 may be larger than those found on typical remote controls, allowing the user to easily access and choose the correct buttons 16. In some embodiments, all of the buttons 16 will have at least one dimension that is at least ½ inch. In some embodiments, all of the buttons 16 will have at least one dimension that is at least ¾ inch. In some embodiments, the remote control device 10 may contain no additional buttons from those described above.

To program the remote control device 10, according to some embodiments of the present invention, a user may push one of the plurality of program buttons 16-2, followed by the enter button 16-4, followed by a channel number on the numeric keypad 16-3, followed by the enter button 16-4. This process can be repeated for each of the plurality of program buttons 16-2. To clear a program from one of the program buttons 16-2, the user may press the program button 16-2, followed by the clear button 16-5. In some embodiments of the present invention, once a channel is cleared from a particular program button 16-2, this program button 16-2 may revert to the previously programmed channel.

To use the remote control device 10, the user may simply toggle between the programs by pressing the next button 16-7 (moving from, for example, program A to program B) or the back button 16-6 (moving from, for example, program B to program A). In some embodiments, pressing the program buttons 16-2 may access the channel programmed into that program button. For example, if the user presses program button A, the channel programmed into program button A may be accessed. If the user then presses program button D, the user may immediately change the channel to the channel programmed in program button D.

It should be understood, of course, that the foregoing relates to exemplary embodiments of the invention and that modifications may be made without departing from the spirit and scope of the invention as set forth in the following claims.

What is claimed is:

1. A remote control device comprising:
a plurality of program buttons, each of the program buttons being programmable to transmit a signal to change a device to a particular television channel;
a next button to toggle forward through the plurality of program buttons; and
a back button to toggle backwards through the plurality of program buttons.

2. The remote control device of claim 1, further comprising keys for programming the plurality of program buttons.

3. The remote control device of claim 1, further comprising a numerical keypad, an enter button and a clear button, the numerical keypad, enter button and clear button selectively depressible, along with the plurality of program buttons, to program the plurality of program buttons.

4. The remote control device of claim 1, wherein each button on the device has at least one dimension that is at least ½ inch.

5. The remote control device of claim 1, wherein each button on the device has at least one dimension that is at least ¾ inch.

6. The remote control device of claim 1, further comprising a housing and a top cover, the housing being bowl shaped.

7. The remote control device of claim 1, further comprising a power button for turning the device on and off.

8. A remote control device consisting essentially of:
a plurality of program buttons, each of the program buttons being programmable to transmit a signal to change a device to a particular television channel;
a next button to toggle forward through the plurality of program buttons;
a back button to toggle backwards through the plurality of program buttons;
a power button for turning the device on and off; and
programming buttons adapted to provide a user a means for programming the plurality of program buttons.

9. The remote control device of claim 8, further comprising a numerical keypad, an enter button and a clear button, the numerical keypad, enter button and clear button selectively depressible, along with the plurality of program buttons, to program the plurality of program buttons.

10. The remote control device of claim 8, wherein each button on the device has at least one dimension that is at least ½ inch.

11. The remote control device of claim 8, wherein each button on the device has at least one dimension that is at least ¾ inch.

12. The remote control device of claim 8, further comprising a housing and a top cover, the housing being bowl shaped.

13. A method for toggling between channels of television programming, the method comprising:
programming a plurality of program buttons of a remote control device, each of the program buttons being programmable to transmit a signal to change a device to a particular television channel;
pressing a next button to toggle forward through the plurality of program buttons; and
pressing a back button to toggle backwards through the plurality of program buttons.

14. The method of claim 13, further comprising pressing a power button to turn a television on and off.

15. The method of claim 13, wherein the step of programming a plurality of program buttons includes:
pressing a desired program button;
pressing an enter button;
pressing a desired channel on a numeric keypad of the remote control device; and
pressing the enter button.

16. The method of claim 13, further comprising clearing the particular television channel associated with a selected program button by:
pressing the selected program button; and
pressing a clear button.
